(19) United States
(12) Patent Application Publication
(10) Pub. No.: US 2003/0081929 A1
(43) Pub. Date: May 1, 2003

(54) Optical ribbon separation methods and tools therefor

(76) Inventors: Gregory A. Lochkovic, Conover, NC (US); John S. Richards, Conover, NC (US); Shail K. Moorjani, Conover, NC (US)

Correspondence Address: CORNING CABLE SYSTEMS LLC, P O BOX 489, HICKORY, NC, 28603, US

(21) Appl. No.: 10/011,665

(22) Filed: Oct. 30, 2001

(51) Int. Cl. G02B 6/00

(52) U.S. Cl. 385/147

(57) ABSTRACT

Methods and tools for separating a fiber optic ribbon into subunits inhibiting optical attenuation during initiation of the separation of the fiber optic ribbon into subunits. A first method includes supplying the fiber optic ribbon, heating a portion of the fiber optic ribbon, and separating the fiber optic ribbon into more than one subunit. The method may be practiced with an optical fiber ribbon heater. The optical fiber ribbon heater transfers heat to a portion of an optical fiber ribbon, thereby softening a matrix material and reducing stress during shearing. The heater may be a stand-alone unit, integrated with a ribbon separation tool, or capable of being removably attached to the tool. Other methods of separating a fiber optic ribbon into subunits include providing a fiber optic ribbon, abrading or oxidizing a portion of the fiber optic ribbon, and separating the fiber optic ribbon into more than one subunit.

### FIELD OF THE INVENTION

The present invention relates generally to fiber optic ribbon separation methods and tools therefor.

### BACKGROUND OF THE INVENTION

Fiber optic cables include optical fibers that are capable of transmitting voice, video, and data signals. Fiber optic cables have advantages over electrical voice, video and data signal carriers, for example, increased data capacity. As businesses and households demand increased data capacity, fiber optic cables can eventually displace electrical voice, video, and data signal carriers.

Some fiber optic cables include optical fibers that are ribbonized. Ribbonizing provides a coplanar array of tightly bound optical fibers held together by at least one material, for example, a UV curable matrix. Fiber optic cables having ribbonized optical fibers are desirable due to associated efficiencies relative to other optical fiber configurations. For example, ribbonized optical fibers provide a suitable geometry for such quick and easy connectorization as mass-fusion splicing.

Optical fiber ribbons have a number of handleability attributes associated therewith; for example, thermal stripability, peelability, furcatability, robustness, and separability. Ribbon thermal stripability is the ability to remove all ribbon matrix material and optical fiber coatings from optical fiber ribbons. An example of using a commercially available ribbon-stripping tool for ribbon thermal stripability is discussed in U.S. Pat. No. 6,289,158. Ribbon peelability involves removal of the matrix from the optical fibers in a continuous fashion while leaving the fiber coatings and colorings intact and free from damage for re-routing or repair. Ribbon furcatabiltity or optical fiber breakout is the ability to remove an individual optical fiber from the ribbon for insertion into an individual fiber furcation tube, for example. Ribbon robustness is the ability of a ribbon, or a sub-unit of that ribbon, to maintain its structural integrity, for example, when subjected to bending, twisting, and/or lateral forces in an enclosure or routing tray. Ribbon separation is the ability to separate subunits, a group of one or more commonly bound coplanar optical fibers, from a ribbon unit for re-routing or repair while maintaining the structural integrity of the subunits. Commercially available tools are available for ribbon separation such as those disclosed in U.S. Pat. Nos. 6,053,085 and 6,115,527. A discussion of ribbon attributes can reviewed in a paper titled “An overview of Key Ribbon Handleability Attributes” presented at the 46^{th} IWCS Proceedings, which is incorporated herein by reference.

### SUMMARY OF THE INVENTION

The present invention is directed to a method of separating a fiber optic ribbon into subunits including the steps of heating a portion of the fiber optic ribbon, and separating the fiber optic ribbon into more than one subunit.

The present invention is further directed to a method of separating a fiber optic ribbon into subunits including the steps of abrading a portion of the fiber optic ribbon, and separating the fiber optic ribbon into more than one subunit.

The present invention is further directed to an optical fiber ribbon heater being operable to transfer heat to a portion of an optical fiber ribbon in order to inhibit attenuation during separation of the optical fiber ribbon into more than one subunit. The optical fiber ribbon heater includes an optical fiber ribbon receiving portion and a heat source. The heat source being operable to transfer heat to the optical fiber ribbon receiving portion. The optical fiber ribbon heater generally excluding heaters having a capturing portion physically gripping a matrix material and/or an optical fiber coating while an optical fiber is removed therefrom.

The present invention is also directed to an optical fiber ribbon separation tool for inhibiting attenuation during separation of an optical fiber ribbon into more than one subunit. The optical fiber ribbon separation tool includes an optical fiber ribbon receiving portion, a shearing device and a heat source. The shearing device is operable to separate the optical fiber ribbon into subunits and the heat source is operable to transfer heat to the optical fiber ribbon receiving portion.

The present invention is still further directed to a method of separating a fiber optic ribbon into subunits including the the steps of oxidizing a portion of the fiber optic ribbon and separating the fiber optic ribbon into more than one subunit.

The present invention is still further directed to a method of separating a fiber optic ribbon into subunits. The method includes the steps of reducing the stress the fiber optic ribbon experiences during initiation by at least one method selected from heating a portion of the fiber optic ribbon, abrading a portion of the fiber optic ribbon, or oxidizing a portion of the fiber optic ribbon and separating the fiber optic ribbon into more than one subunit.

### BRIEF DESCRIPTION OF THE FIGURES

FIG. 1 is a cross-sectional view of an exemplary optical fiber ribbon.

FIG. 2 is a cross-sectional view of an exemplary optical fiber ribbon that is separated into subunits.

FIG. 3 illustrates a representative graph indicating average delta attenuation of various separation methods versus time during initiation of a ribbon separation for an optical fiber that is adjacent to the point of ribbon separation.

FIG. 4a is an isometric view of an exemplary heating element according to the present invention.

FIG. 4b is an isometric view of an exemplary heating element according to another embodiment of the present invention.

FIG. 4c is an isometric view of an exemplary heating element according to yet another embodiment of the present invention.

FIG. 5 is an exploded isometric view of an exemplary ribbon separation tool according to the present invention.

FIG. 6 is an isometric assembly view of the exemplary ribbon separation tool of FIG. 5 showing three optical fiber ribbons arranged for insertion into the ribbon separation tool.

FIG. 7 is a cross-sectional view of the exemplary ribbon separation tool according to the present invention.

FIG. 8 is a cross-sectional view of the exemplary ribbon separation tool similar to FIG. 6 showing the ribbon separation tool in the actuated position whereby the optical fiber ribbons have been sheared.

### DETAILED DESCRIPTION OF THE INVENTIONS

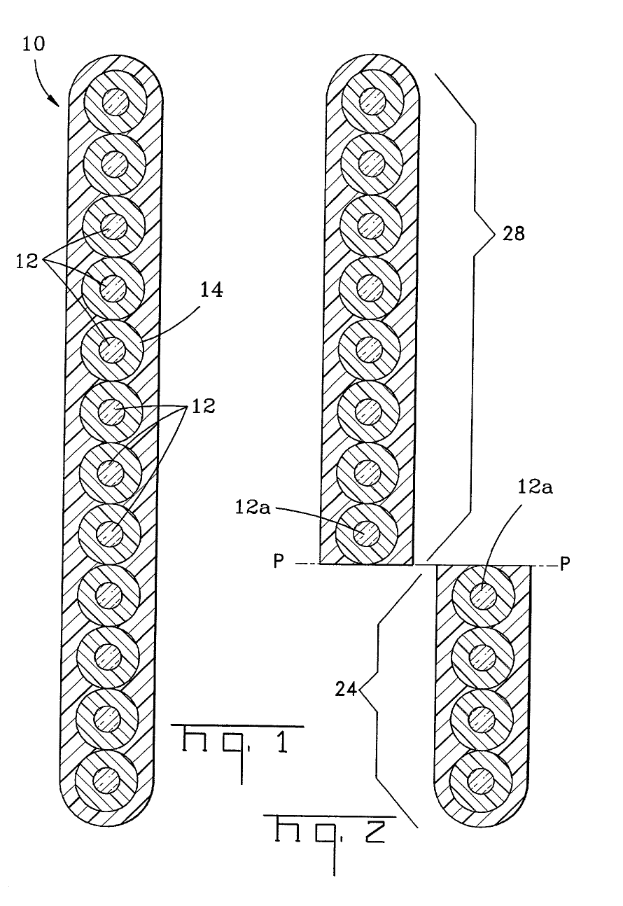

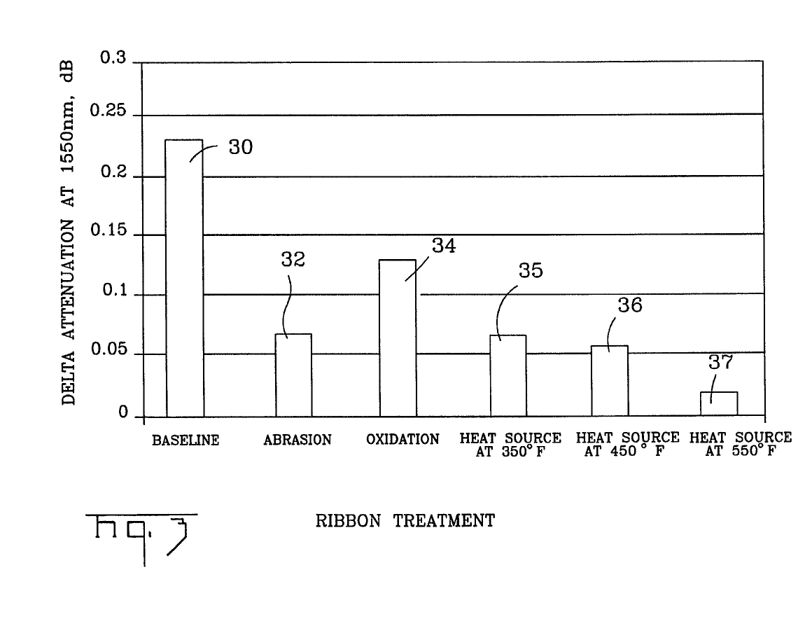

FIG. 1 illustrates an exemplary optical fiber ribbon 10, (hereinafter ribbon 10) including at least one optical fiber(s) 12 and at least one matrix material 14. More specifically, ribbon 10 includes twelve single-mode optical fibers in a UV curable matrix, however other suitable matrix materials, optical fiber types and/or numbers of optical fibers may be used. While at least one of the optical fiber(s) 12 is carrying a signal, craftsman may be required to separate ribbon 10 into multiple subunits for lengths of up to one meter or more. When optical fiber(s) 12 is carrying a signal it is desirable to maintain relatively low delta optical attenuation values to inhibit disrupting transmission of the signal. FIG. 2 schematically depicts an optical fiber ribbon that is separated into subunits 24 and 28, for example, an eight and four optical fiber subunit, however other suitable numbers of optical fiber(s) 12 can contained in subunits 24 and 28.

In general, the present inventors have discovered that optical fiber(s) 12a adjacent to a separation plane P experience the highest level of stress during separation of ribbon 10 into subunits, and, therefore, optical fibers 12a are generally susceptible to the highest delta attenuation during separation. In general, separation of ribbon 10 includes two components of separation delta attenuation performance. The two components of separation delta attenuation performance are an initiation component and a lengthwise advancement component.

The initiation component is due to a tear or fracture in the axial direction in the matrix material and includes initial separation of matrix material 14 and optical fibers 12 at separation plane P. The lengthwise advancement component includes advancing the initial separation of matrix material 14 and optical fibers 12 by, for example, pulling a ribbon separation tool along the length being separated. The delta attenuation occurring during the lengthwise advancement component is a function of the delta attenuation during the initiation component of separation coupled with any stresses accumulated during advancement. Therefore, a generally lower initiation component of separation delta attenuation may minimize the potential for large delta attenuation performance during the lengthwise advancement component of the separation of ribbon 10 into subunits 24 and 28. Additionally, separating ribbon 10 into subunits with a separation tool generally provides consistently lower delta attenuation performance over hand separation techniques by minimizing variations in mechanical stresses induced during the process. The measured results presented herein are representative of only the initiation component of separation, however, the concepts of the present invention can advantageously likewise reduce the lengthwise advancement component of separation.

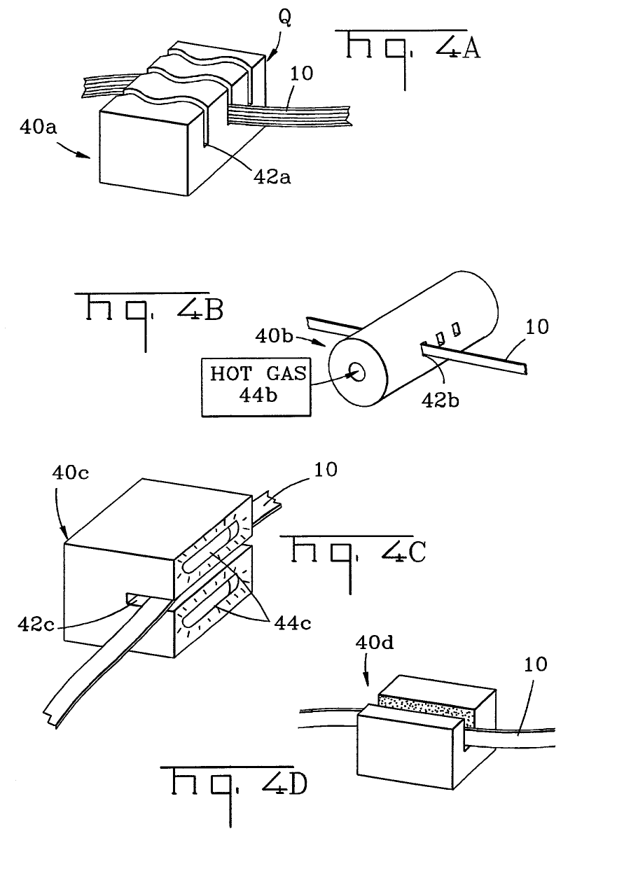

FIG. 3 illustrates an exemplary delta attenuation of the initiation component during the separation of ribbon 10 into subunits. As a baseline, the present inventors used a ribbon separation tool and measured the maximum delta attenuation during the initiation of separation of ribbon 10 into subunits and calculated an average delta attenuation. In particular, bar 30 represents the average delta attenuation for optical fibers 12a, which are adjacent to the separation plane P, during a separation performed on ribbon 10 at ambient room temperature with a ribbon separation tool similar to the one described in U.S. Pat. Nos. 6,053,085 and 6,115,527; however, other suitable ribbon separation tools may be used. The average delta attenuation of the baseline test was about 0.230 dB. As illustrated, bar 30 defines a maximum optical attenuation during the initiation of separation of ribbon 10 into subunits by the ribbon separation tool.

The present inventors investigated various methods and/or techniques to reduce the average measured delta attenuation in optical fiber(s) 12a during initiation of separation at a reference wavelength of 1550 nm. The methods and/or techniques generally included treating about a two-inch portion of ribbon 10 in the area being separated. One method consisted of mechanically stress hardening ribbon 10 over an edge at the intended point of separation into subunits, however, this method actually slightly increased the average delta attenuation compared with the baseline measured delta attenuation of 0.230 dB.

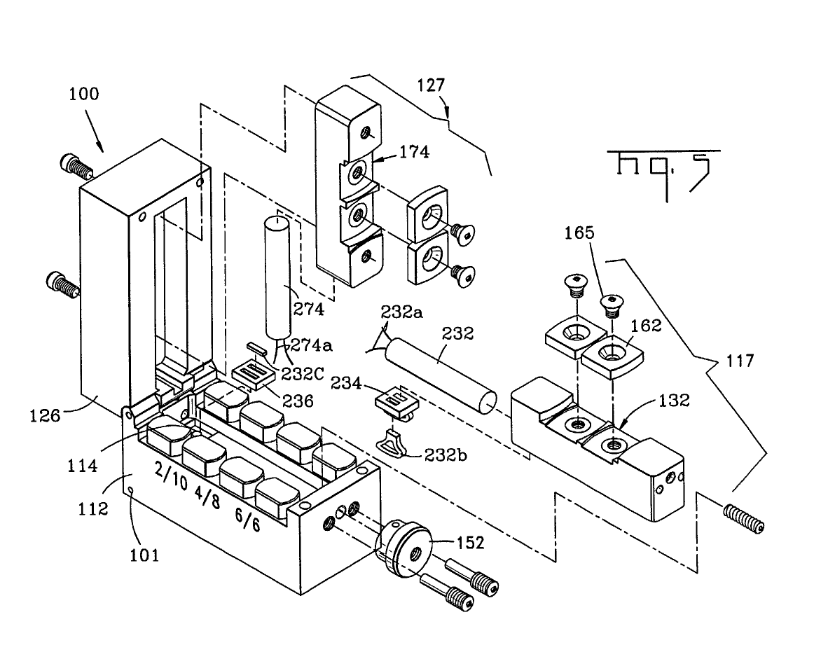

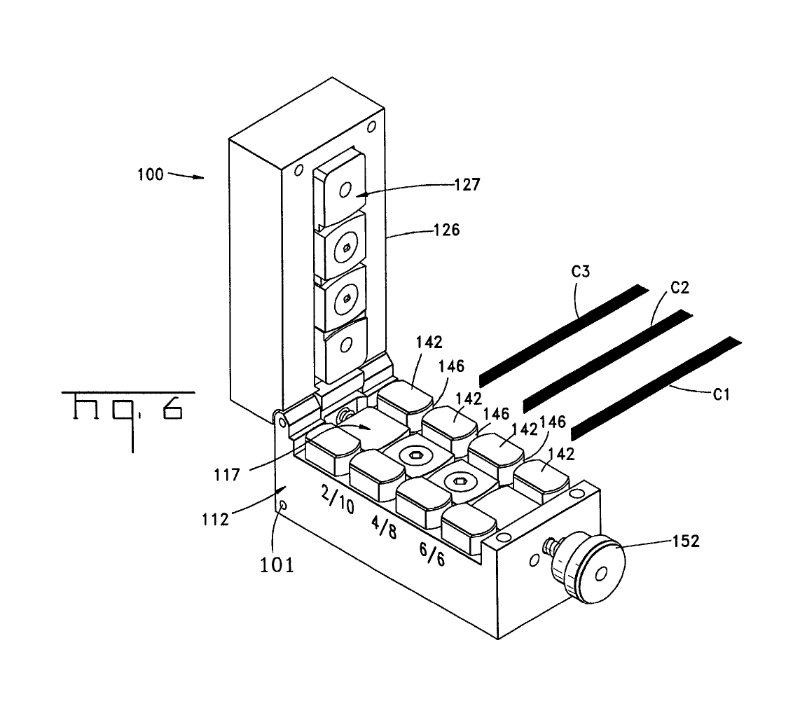

In another method, the present inventors abraded both sides of ribbon 10 with a 240-grit sandpaper in the area of separation, however other suitable abrasive materials, such as, emory cloth may be used. The present inventors believe that abrasion of ribbon 10 weakens matrix material 14 requiring a lower force to initiate separation into subunits. Abrasion with sandpaper resulted in a reduction of the average delta attenuation of optical fibers 12a during initial separation. More specifically, abrasion resulted in about a factor of three reduction in the average delta attenuation compared with the baseline test. More specifically, abrasion resulted in an average delta attenuation of about 0.070 dB as shown in bar 32 of FIG. 3. Abrasion may be preformed with an abrasion tool 40d, as shown in FIG. 4d that applies a predetermined pressure between the abrasive material and at least one planar surface of ribbon 10. For example, ribbon 10 can be passed through and/or passed by at least one channel 42d or surface. Channel 42c may be adjustable in width to control the abrasion on ribbon 10.

The present inventors have surprisingly discovered that heating ribbon 10 before the initiation of separation into subunits generally provided the greatest reduction of measured delta attenuation in optical fiber(s) 12a during separation. The present invention should not be confused with ribbon thermal stripability. Ribbon thermal stripability requires physically removing and/or stripping ribbon matrix material and optical fiber coatings from the ribbon so that the optical fibers may be connectorized. Typical stripping tools require placing the ribbon in a holder with the portion to be stripped extending beyond the holder. The portion extending beyond the holder is captured and/or clamped between a platen and the inside surface of a lid. Upon closure of the lid, opposing blades are positioned to cut partially into opposite sides of the ribbon so that a well-defined break in the optical fiber coating can be made. The portion of the ribbon to be stripped is then heated to weaken/break the adhesive bond at an interface between the optical fiber coating and the optical fiber. Next, the optical fibers are moved relative to the optical fiber coating and matrix material, which is physically gripped by the platen and inside surface of the lid, physically stripping the optical fibers from the matrix material and/or the optical fiber coatings. The optical fiber coatings and/or matrix material remains between the platen and the inside surface of the lid.

Whereas, the present invention heats ribbon 10 for separating ribbon 10 into subunits 24 and 28 with minimal induced attenuation. Moreover, the intent of the present invention is not to strip away matrix material and/or optical fiber coatings, rather, matrix material 14 is generally intact on subunits 24 and 28 to advantageously maintain the structural integrity of subunits 24 and 28. Thus, optical fiber ribbon heaters of the present invention generally excludes heaters with a capturing and/or clamping portion intended to hold matrix material and/or optical fiber coatings while removing the optical fiber therefrom.

In one test, the present inventors used a flame to oxidize the surface of ribbon 10 before separating ribbon 10 into subunits. The present inventors believe that oxidizing the surface of ribbon 10 results in a brittle material that fractures easier during initiation of separation. The flame resulted in a reduction of the average delta attenuation. More specifically, flame heating resulted in an average delta attenuation of about 0.133 dB as shown in bar 34 of FIG. 3. A flame of an oxidation tool, such as a cigarette lighter or other suitable oxidation tool, which oxidizes a portion of ribbon 10, may perform the oxidation step.

Next, the present inventors employed a variable temperature soldering iron as a heat source to transfer heat to ribbon 10 before initiation of separation. The present inventors believe that the application of heat softens matrix material 14 of ribbon 10 resulting in lower mechanical stresses during separation. The present inventors experimented using a soldering iron, with a digital temperature readout, to heat ribbon 10 by rubbing the soldering iron back and forth on both sides of ribbon 10 for about five seconds then quickly separated ribbon 10 into subunits using a ribbon separation tool. In the first test, the soldering iron was set at 350° F., this yielded an average delta attenuation value of about 0.070 dB as shown in bar 35 of FIG. 3. In the second test, the soldering iron was set at 450° F., this yielded an average delta attenuation value of about 0.062 dB as shown in bar 36 of FIG. 3. In the third test, the soldering iron was set at 550° F., this yielded an average delta attenuation of about 0.023 as shown in bar 37 of FIG. 3. The present inventors were further surprised to discover that the average delta attenuation at 550° F. was reduced by a factor of 10 compared with the baseline attenuation results.

The inventors of the present invention have discovered that heating ribbon 10 to inhibit delta attenuation can be accomplished in a range of temperatures. For example, from about 70° F. or lower to about 550° F. or more. However, lower temperature ranges may improve, i.e., decrease, average delta attenuation at initial separation in relatively cold climatic conditions by providing an increase in ribbon temperature. Ribbon 10 can be heated in a variety of ways, for example, through conduction, convection, radiation, or combinations thereof. Moreover, a separation tool having an internal heat source can, for example, heat ribbon 10 or ribbon 10 can be heated externally of a separation tool. An optical fiber ribbon heater includes a ribbon receiving portion and a heat source to generally transfer heat towards said ribbon receiving portion.

In one embodiment of the present invention, a heat source that is external to a separation tool primarily heats ribbon 10 through conduction, however other suitable heating methods may also be included. For example, FIG. 4a schematically illustrates a heater 40a having at least one channel 42a to pass ribbon 10 therethrough in order to heat the ribbon. Channel 42a may be curvilinear so that ribbon 10 contacts both sides of channel 42a to maximize the contact area and/or heat transfer Q between channel 42a and ribbon 10, when ribbon 10 is moving through channel 42a. Channel 42a can include, for example, electrical resistive heating elements embedded therein to heat channel 42a. Heating elements 44a can be powered by an AC or DC source and that source may be either integrated with heater 40a or external to heater 40a.

In another embodiment, a heat source that is external to a separation tool primarily heats ribbon 10 through convection, however other suitable heating methods may also be included. For example, FIG. 4b schematically illustrates a heater 40b having at least one convection heat source 44b, such as, a hot gas. Ribbon 10 can be passed through at least one channel 42b transferring heat from the hot gas to ribbon 10. Convection heat source 44b can be provided by, for example, burning a fuel or a resistive heat element and that source may be either integrated with heater 40b or external to heater 40b.

In yet another embodiment, a heat source that is external to a separation tool primarily heats ribbon 10 through radiation, however other suitable heating methods may also be included. For example, FIG. 4c schematically illustrates a heater 40c having at least one radiation heat source 44c, for example, a halogen heater that may transfer heat through radiation and/or convection. Ribbon 10 can be passed through at least one channel 42 transferring heat from heat source 44c to ribbon 10. Radiation heat source 44c can be powered by an AC or DC source and that source may be either integrated with heater 40c or external to heater 40c.

In another experiment the present inventors used radiation heat source 44c, more specifically, a halogen heat source to heat ribbon 10, varying times and temperatures, before initiation of separation of ribbon 10 into subunits. The inventors measured an initiation of separation baseline delta attenuation at ambient temperature for a first and second optical fiber 12a and averaged the results for the first and second optical fibers 12a separately, rather than averaging the measurements of the first and second optical fiber together as with the delta attenuation results. The first optical fiber 12a was adjacent to a first side of the plane of separation and the second optical fiber was adjacent to a second side of the plane of separation. The present inventors discovered that one of optical fibers 12a generally includes a higher attenuation value during initiation of separation. The present inventors believe this is due to the relative position of each fiber in relation to the shearing surfaces from one ribbon to the next. More specifically, first optical fiber 12a had an average baseline delta attenuation of 0.011 dB and second optical fiber 12a had an average baseline delta attenuation of 0.2212 dB.

Illustrative of the results, the present inventors measured the temperature near radiation heat source 44c to be about 300° F. and varied the time that ribbon 10 was held near heat source 44c. Average delta attenuation may be minimized by varying the heat transfer rate and the time ribbon 10 is exposed to the heat source. For example, with an exposure time of about ten seconds the average delta attenuation was significantly reduced. More specifically, first optical fiber 12a had an average delta attenuation of about 0.0066 dB and second optical fiber had an average delta attenuation of about 0.0174 dB. For the ten-second exposure time, second optical fiber 12a included a reduction of the average delta attenuation greater than a factor of ten. With an exposure time of about twenty seconds, first optical fiber 12a had an average delta attenuation of about 0.0049 dB and second optical fiber had an average delta attenuation of about 0.0374 dB. For the twenty-second exposure time, second optical fiber 12a included a reduction of the average delta attenuation of about a factor of six. In general, the reduction in average delta attenuation was greatest in the optical fiber 12a that experienced the higher average delta attenuation during the baseline test.

In accordance with the present inventive concepts, heaters 40a, 40b, and/or 40c may include a temperature control for different heat settings, an automatic power down feature when the heater is not being used, an indicator signal, such as, a LED or audible noise to notify the craftsman that the heater is at the desired temperature and/or a temperature monitoring device, such as, a thermistor to control the heat source. Heater 40a, 40b, and/or 40c may also include a casing to thermally insulate the outer portions of the heater so that a craftsman may handle the heater without suffering discomfort and/or injury.

In another embodiment of the present invention a heat source can be integrated with a separation tool. For example, a separation tool 100 similar to the separation tool disclosed in U.S. Pat. Nos. 6,053,085 and 6,115,527 is illustrated in FIG. 5. However, other suitable separation tools may integrate a heat source to practice the concepts of the present invention, for example, separation tools similar to those disclosed in U.S. Pat. Nos. 5,685,945, 5,926,598, and 5,944,949.

Separation tool 100 is described as an exemplary modification to separation tool 10 disclosed in U.S. Pat. Nos. 6,053,085 and 6,115,527, both of which are incorporated herein by reference. This discussion will focus on the addition of at least one heat source to separation tool 10 of the aforementioned U.S. Pats. incorporated herein by reference. Other details of separation tool 100 of the present invention are similar to separation tool 10 of the U.S. Pats. incorporated herein by reference and can be studied therein.

As illustrated in FIG. 5, ribbon separation tool 100 includes a stationary shearing device 127 and a moveable shearing device 117. Moveable shearing device 117 is operative to move relative to stationary shearing device 127 during a shearing stroke. Moveable shearing device 117 includes a carrier 132, multi-edge inserts 162, and threaded fasteners 165 to secure inserts 162. Carriers 132, 174 include a height to accommodate a heat source, for instance, an electrically resistive heat source. Carriers 132, 174 include a bore 134, 176 (not visible) for receiving respective heat sources 232, 274. FIG. 5 schematically illustrates electrical leads 232a, 274a that supply power to heat sources 232, 274, however leads 232a, 274a can be, for example, female contacts or other suitable electrical contacts that conduct power to heat sources 232, 274. Because carrier 132 is movable, leads 232a of heat source 232 may be electrically connected to, for example, electrical contacts 232b having a wiping surface. More specifically, two electrical contacts 232b may be housed in a dielectric insert 234 that is attached to carrier 132 in a predetermined position so that electrical contacts 232b make an electrical connection with corresponding electrical contacts 232c housed in a dielectric insert 236 located in a predetermined position on a floor 114 of a base 112. Contacts 232b may include a resilient body to bias the wiping surface of contact 232b towards contact 232c to promote a suitable electrical connection. Contacts 232b may also include a male blade portion that electrically attaches to leads 232a, which may be female electrical contacts on heat source 232. Contacts 232c includes leads that are routed to the power source or power source input of separation tool 100. Likewise, leads 274a of heat source 274 can be routed from a cover member 126 to an access bore in the rear of base 112 to a power source or a power source input 101 of separation tool 100 disposed on base 112. A boot (not shown) may be used to protect leads 274a between cover member 126 and base 112. However, other suitable configurations may be employed to route power to other suitable heat sources integrated in a separation tool.

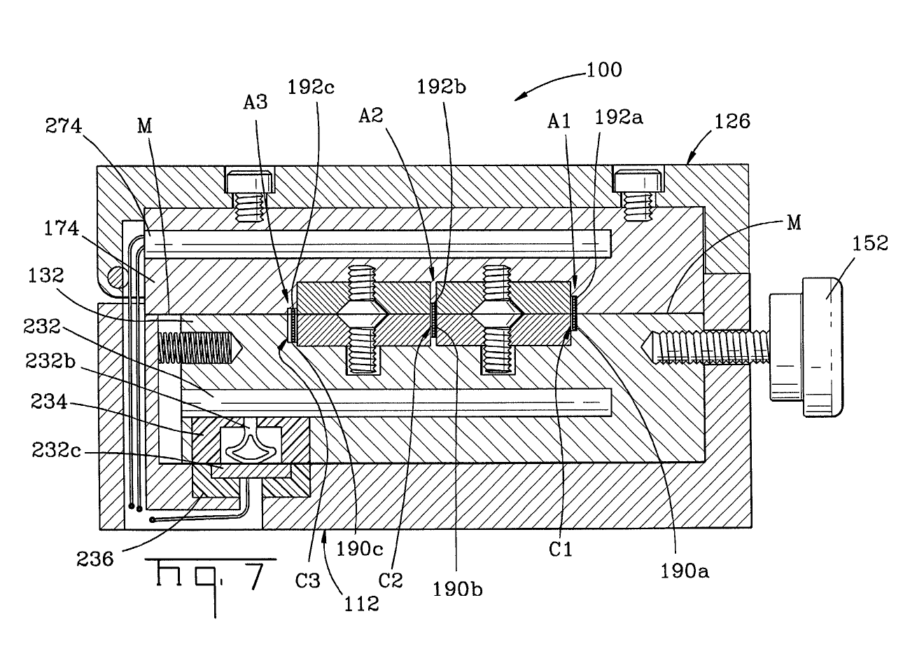

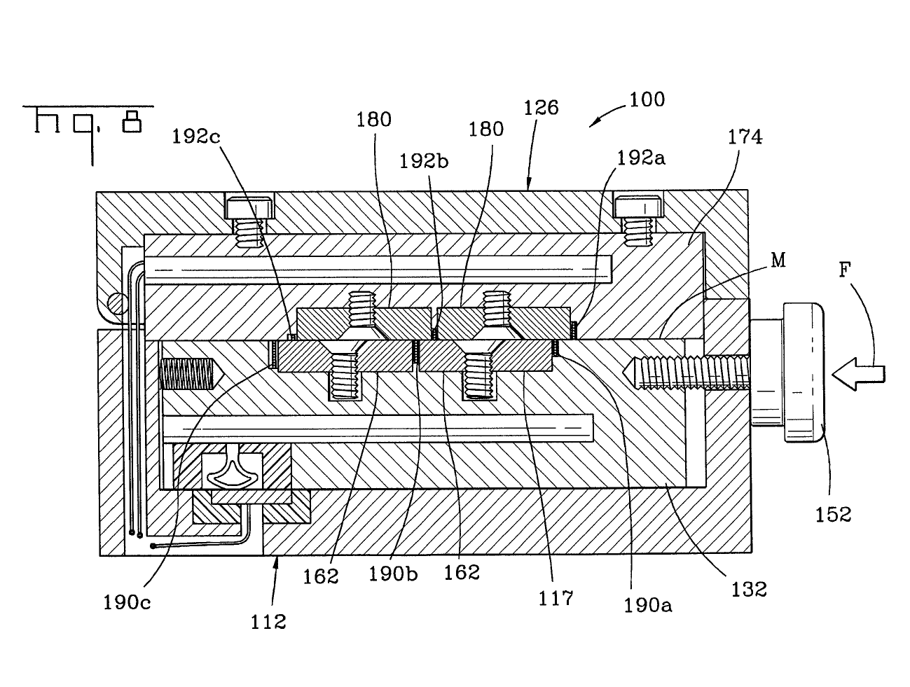

FIG. 6 illustrates ribbon support members 142, with ribbon receiving slots 146 being defined therebetween, that are adjacent shearing devices 117, 127. Moveable shearing device 117 is movably located between ribbon support members 142 and includes movable sub-slots 190a, 190b, 190c as depicted in FIGS. 7 and 8. When cover member 126 of separation tool 100 is in a closed position, stationary sub-slots 192a, 192b, 192c of stationary shearing device 127 are aligned with moveable sub-slots 190a, 190b, 190c to define shearing slots 190a, 192a; 190b, 192b; 190c, 192c. Shearing slots 190a, 192a; 190b, 192b; 190c, 192c are each sized to receive a respective optical fiber ribbon C1, C2, C3, and each shearing slot straddles a shearing plane M defined between shearing devices 117, 127. When tool 100 is actuated by pushing a pusher member 152 to an actuated position, ribbon C1 will be separated into two 6-fiber subunits, ribbon C2 will be separated into one 4-fiber and one 8-fiber subunit, and ribbon C3 will be separated into one 2-fiber subunit and one 10-fiber subunit, however other suitable subunit separations may be employed. With pusher member 152 in the actuated position, ribbons C1, C2, C3 may then be moved lengthwise to separate a length of ribbon.

Separation tool 100 may include any of the following features: a temperature control for different heat settings; an automatic power down; a safety interconnect that only allows heating when cover 126 is in a closed position; an indicator signal, such as, a LED or audible noise to notify the craftsman that the heater is at the desired temperature; temperature monitoring device, such as, a thermistor to control the temperature; and/or a casing to thermally insulate the outer portions of the heater so that a craftsman may handle separation tool 100 without suffering discomfort and/or injury.

Other suitable configurations and/or modifications of separation tool 100 may be made while still practicing the concepts of the present invention. For example, instead of inserting a heat source into a bore on carriers 132, 174, inserts 132, 180 may be an electrically resistive heat source. In another embodiment, ribbon support elements 142 may be heated, for example, by an electrically resistive heat source. Other embodiments may include single or multi-slot tools. In yet another embodiment, air passages are machined into ribbon support elements 142 allowing a hot gas to flow through the passages heating ribbon 10. Additionally, machining the insert profiles directly on carriers 132 and 174 can eliminate inserts 162 and 180. A separation tool may also include any suitable combination of heat sources and configurations allowing the craftsman flexibility. For example, where no power source is available a ribbon separation tool may include an abrasion portion thereon for abrading the ribbon before and/or during separation.

A heat source may also be external to the separation tool, but capable of removable attachment or fixed thereto. For example, a heat source, such as, 40a, 40b, 40c, may be removably attached to the separation tool by, for instance, magnetic, mechanical or other suitable means for being removed when not employed resulting in a separation tool that can be adapted according to the requirements of the craftsman.

In view of the present disclosure, many modifications and other embodiments of the present invention, within the scope of the appended claims, will become apparent to a skilled artisan. For example, other suitable separation tools can incorporate heating elements or employ external heating elements heating the ribbon before separation by the tool. Additionally, conduction, convection and/or radiation heating may be used in various combinations. Therefore, it is to be understood that the present inventions are not to be limited to the specific embodiments disclosed herein and that modifications and other embodiments are intended to be included within the scope of the appended claims. Although specific terms are employed herein, they are used in a generic and descriptive sense only and not for purposes of limitation. The invention has been described with reference to separation of ribbons into subunits with a ribbon separation tool but the inventive concepts of the present invention are applicable to other suitable methods of separating ribbons into subunits as well.

That which is claimed:

1. A method of separating a fiber optic ribbon into subunits comprising the steps of:
supplying said fiber optic ribbon;
heating a portion of said fiber optic ribbon; and
separating said fiber optic ribbon into more than one subunit.

2. The method according to claim 1, said heating step further comprising heat being transferred to said fiber optic ribbon by one of the methods being selected from conduction, convection, radiation, or combinations thereof.

3. The method according to claim 1, said heating step further comprising heating said portion of said fiber optic ribbon to at least about 70° F. or more.

4. The method according to claim 1, said heating step further comprising heating said portion of said fiber optic ribbon to about 550° F. or less.

5. The method according to claim 1, said heating step further comprising heating said portion of said fiber optic ribbon within a range of about 70° F. and about 550° F.

6. The method according to claim 1, said separating step being accomplished with an optical ribbon separation tool.

7. The method according to claim 1, said method having an average measured delta attenuation during initiation of separation of about 0.150 dB or less in an optical fiber adjacent to a separation plane.

8. A method of separating a fiber optic ribbon into subunits comprising the steps of:
supplying said fiber optic ribbon;
abrading a portion of said fiber optic ribbon; and
separating said fiber optic ribbon into more than one subunit.

9. The method according to claim 8, said separating step being accomplished with an optical ribbon separation tool.

10. The method according to claim 8, said method having an average measured delta attenuation during initiation of separation of about 0.150 dB or less in an optical fiber adjacent to a separation plane.

11. The method according to claim 8, said method being performed with an abrasion tool.

12. An optical fiber ribbon heater, said optical fiber ribbon heater being operable to transfer heat to a portion of an optical fiber ribbon in order to inhibit attenuation during separation of said optical fiber ribbon into more than one subunit, said optical fiber ribbon heater comprising:
an optical fiber ribbon receiving portion;
a heat source, said heat source being operable to transfer heat to said optical fiber ribbon receiving portion; and
said optical fiber ribbon heater generally excluding heaters having a capturing portion physically gripping a matrix material and/or an optical fiber coating while an optical fiber is removed therefrom.

13. The optical fiber ribbon heater according to claim 12, said optical fiber heater raising the temperature of said optical fiber ribbon by one of the methods being selected from conduction, convection, radiation, or combinations thereof.

14. The optical fiber ribbon heater according to claim 12, said optical fiber ribbon heater being able to transfer heat to said fiber optic ribbon to raise the temperature of a portion of said fiber optic ribbon within the range of about 70° F. to about 550° F.

15. The optical fiber ribbon heater according to claim 12, said optical fiber ribbon heater being powered by a source being selected from a direct current or an alternating current.

16. The optical fiber ribbon heater according to claim 12, said optical fiber ribbon heater further comprising an integral power source.

17. The optical fiber ribbon heater according to claim 12, said optical fiber ribbon heater having at least one portion thereof for receiving a portion of at least one optical fiber ribbon.

18. The optical fiber ribbon heater according to claim 12, said optical fiber ribbon heater being part of a ribbon separation tool.

19. The optical fiber ribbon heater according to claim 12, said optical fiber ribbon heater being removably attachable to a ribbon separation tool.

20. An optical fiber ribbon separation tool for inhibiting attenuation during separation of an optical fiber ribbon into more than one subunit, said optical fiber ribbon separation tool comprising:
an optical fiber ribbon receiving portion;
a shearing device being operable to separate said optical fiber ribbon into subunits; and
a heat source being operable to transfer heat to said optical fiber ribbon receiving portion.

21. The optical fiber ribbon separation tool according to claim 20, said optical fiber ribbon separation tool being capable of raising the temperature of a optical fiber ribbon by one of the methods being selected from conduction, convection, radiation, or combinations thereof.

22. The optical fiber ribbon separation tool according to claim 20, said optical fiber ribbon separation tool being capable of transferring heat to a fiber optic ribbon to raise the temperature of a portion of said fiber optic ribbon within the range of about 70° F. to about 550° F.

23. The optical fiber ribbon separation tool according to claim 20, said optical fiber ribbon separation tool being powered by a source being selected from a direct current or an alternating current.

24. The optical fiber ribbon separation tool according to claim 20, further comprising an integral power source.

25. The optical fiber ribbon separation tool according to claim 20, said heat source being removably attached to said optical fiber ribbon separation tool.

26. The optical fiber ribbon separation tool according to claim 20, an optical fiber adjacent to a separation plane having an average measured delta attenuation during initiation of separation of about 0.150 dB or less.

27. A method of separating a fiber optic ribbon into subunits comprising the steps of:
supplying said fiber optic ribbon;
oxidizing a portion of said fiber optic ribbon; and
separating said fiber optic ribbon into more than one subunit.

28. The method of separating a fiber optic ribbon into subunits according to claim 27, said method being performed with an oxidation tool.

29. A method of separating a fiber optic ribbon into subunits comprising the steps of:
supplying said fiber optic ribbon;
reducing the stress said fiber optic ribbon experiences during initiation by at least one method selected from heating a portion of said fiber optic ribbon, abrading a portion of said fiber optic ribbon, or oxidizing a portion of said fiber optic ribbon;
separating said fiber optic ribbon into more than one subunit.
